(19) United States
(12) Patent Application Publication
(10) Pub. No.: US 2023/0004885 A1
(43) Pub. Date: Jan. 5, 2023

(54) SYSTEMS AND METHODS FOR PROCESSING EXPERIMENTAL WORKFLOWS AT REMOTE LABORATORIES

(71) Applicant: STRATEOS, INC., Menlo Park, CA (US)

(72) Inventors: Vanessa Biggers, San Francisco, CA (US); Eriberto Lopez, Costa Mesa, CA (US); Joshua David Nowak, San Jose, CA (US)

(21) Appl. No.: 17/854,700

(22) Filed: Jun. 30, 2022

Related U.S. Application Data
(60) Provisional application No. 63/218,265, filed on Jul. 2, 2021.

(51) Int. Cl. G06Q 10/06; G01N 35/00

(52) U.S. Cl. CPC G06Q 10/0633; G01N 35/00871; G01N 2035/0091

(57) ABSTRACT

System and method for processing one or more experimental workflows. For example, the method includes receiving an indication of an experimental workflow selected by a user, generating workflow configuration requirements for the experimental workflow, presenting a user interface to enable input of parameters to configure the experimental workflow in accordance with the workflow configuration requirements, performing a validation of the parameters, configuring the experimental workflow based upon the validated parameters, and transforming the configured experimental workflow into machine executable codes for execution by devices at remote laboratories.

### CROSS-REFERENCE TO RELATED APPLICATIONS

This application claims priority to U.S. Provisional Patent Application No. 63/218,265, filed Jul. 2, 2021, which is incorporated by reference herein for all purposes.

The following four applications, including this one, are being filed concurrently and the other applications are hereby incorporated by reference in their entirety for all purposes:

1. U.S. patent application Ser. No. ______, titled “Systems and Methods for Processing Experimental Workflows at Remote Laboratories” (Attorney Docket Number 520295.000014); and

2. U.S. patent application Ser. No. ______, titled “Systems and Methods for Managing Experimental Requests at Remote Laboratories” (Attorney Docket Number 520295.000015).

3. U.S. patent application Ser. No. ______, titled “Systems and Methods for Processing Experimental Requests at Remote Laboratories” (Attorney Docket Number 520295.000016).

4. U.S. patent application Ser. No. ______, titled “Systems and Methods for Performing Experiments at Remote Laboratories” (Attorney Docket Number 520295.000017).

### FIELD OF THE DISCLOSURE

Some embodiments of the present disclosure are directed to processing experimental workflows. More particularly, certain embodiments of the present disclosure provide systems and methods for selecting and configuring an experimental workflow. Merely by way of example, the present disclosure has been applied to executing the configured experimental workflow at a remote laboratory. But it would be recognized that the present disclosure has much broader range of applicability.

### BACKGROUND OF THE DISCLOSURE

Experiments performed at designated laboratories are limited by existing infrastructure. Remote laboratories, on the other hand, provide the opportunity to carry out different experiments with different scope at the same time. Accordingly, there exists a need to develop techniques that can enable users to scale to remote laboratory infrastructures when needing capability and/or capacity.

### BRIEF SUMMARY OF THE DISCLOSURE

Some embodiments of the present disclosure are directed to processing experimental workflows. More particularly, certain embodiments of the present disclosure provide systems and methods for selecting and configuring an experimental workflow. Merely by way of example, the present disclosure has been applied to executing the configured experimental workflow at a remote laboratory. But it would be recognized that the present disclosure has much broader range of applicability.

According to certain embodiments, a method for processing one or more experimental workflows includes receiving an indication of an experimental workflow selected by a user. Also, the method includes generating workflow configuration requirements for the experimental workflow. Further, the method includes presenting a user interface to enable input of one or more parameters to configure the experimental workflow in accordance with the workflow configuration requirements. Moreover, the method includes performing a validation of the one or more parameters to configure the experimental workflow and configuring the experimental workflow based at least in part upon the validated one or more parameters. In addition, the method includes transforming the configured experimental workflow into one or more machine executable codes for execution by one or more devices at one or more remote laboratories.

According to some embodiments, a system for processing one or more experimental workflows includes one or more processors and a memory storing instructions for execution by the one or more processors. The instructions, when executed by the one or more processors, cause the system to receive an indication of an experimental workflow selected by a user. Also, the instructions, when executed by the one or more processors, cause the system to generate workflow configuration requirements for the experimental workflow. Further, the instructions, when executed by the one or more processors, cause the system to present a user interface to enable input of one or more parameters to configure the experimental workflow in accordance with the workflow configuration requirements. Moreover, the instructions, when executed by the one or more processors, cause the system to perform a validation of the one or more parameters to configure the experimental workflow and configure the experimental workflow based at least in part upon the validated one or more parameters. In addition, the instructions, when executed by the one or more processors, cause the system to transform the configured experimental workflow into one or more machine executable codes for execution by one or more devices at one or more remote laboratories.

According to certain embodiments, a non-transitory computer-readable medium stores instructions for processing one or more experimental workflows. The instructions are executed by one or more processors of a computing device. The non-transitory computer-readable medium includes instructions to receive an indication of an experimental workflow selected by a user. Also, the non-transitory computer-readable medium includes instructions to generate workflow configuration requirements for the experimental workflow. Further, the non-transitory computer-readable medium includes instructions to present a user interface to enable input of one or more parameters to configure the experimental workflow in accordance with the workflow configuration requirements. Moreover, the non-transitory computer-readable medium includes instructions to perform a validation of the one or more parameters to configure the experimental workflow and configure the experimental workflow based at least in part upon the validated one or more parameters. In addition, the non-transitory computer-readable medium includes instructions to transform the configured experimental workflow into one or more machine executable codes for execution by one or more devices at one or more remote laboratories.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified method for processing experimental workflows according to certain embodiments of the present disclosure.

FIG. 2 shows a simplified system for processing experimental workflows according to certain embodiments of the present disclosure.

FIG. 3 shows a simplified diagram illustrating various modules for processing experimental workflows according to certain embodiments of the present disclosure.

### DETAILED DESCRIPTION OF THE DISCLOSURE

Some embodiments of the present disclosure are directed to processing experimental workflows. More particularly, certain embodiments of the present disclosure provide systems and methods for selecting and configuring an experimental workflow. Merely by way of example, the present disclosure has been applied to executing the configured experimental workflow at a remote laboratory. But it would be recognized that the present disclosure has much broader range of applicability.

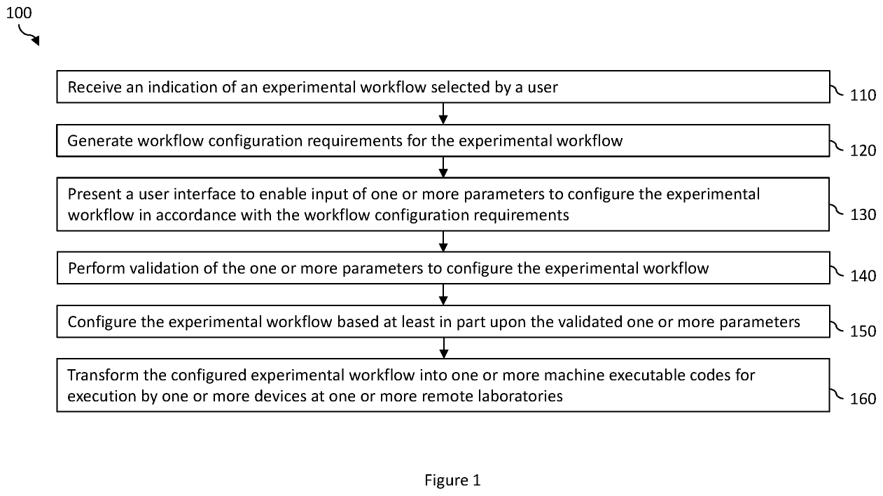

FIG. 1 shows a simplified method for processing experimental workflows according to certain embodiments of the present disclosure. This figure is merely an example, which should not unduly limit the scope of the claims. One of ordinary skill in the art would recognize many variations, alternatives, and modifications. The method 100 includes process 110 for receiving an experimental workflow, process 120 for generating experimental workflow requirements, process 130 for presenting a user interface, process 140 for validating parameters, process 150 for configuring the experimental workflow, and process 160 for executing the experimental workflow. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced.

For example, some or all processes of the method are performed by a computing device or a processor directed by instructions stored in memory. As an example, some or all processes of the method are performed according to instructions stored in a non-transitory computer-readable medium.

At the process 110, an indication of the experimental workflow selected by a user is received according to certain embodiments. In some embodiments, a list of available experimental workflows is published for the user to select. In certain embodiments, the published list is generated based upon user data (e.g., user's access level, user group assignment, etc.) and/or experimental application data (e.g., experiment purpose, intended use, error tolerance, etc.).

At the process 120, workflow configuration requirements for the experimental workflow are generated according to certain embodiments. In some embodiments, the workflow configuration requirements include input type entities, data generated, workflow version, and/or published date.

At the process 130, the user interface is presented to enable input of one or more parameters to configure the experimental workflow according to certain embodiments. In various embodiments, the user interface is a configurable interface that allows the user to enter the one or more parameters to modify or customize the experimental workflow. For example, the one or more parameters include entities such as volume, comma separated value (CSV) configurations, and/or plate maps. In some embodiments, the user interface provides one or more fields which allow the user to select components from various sources such as laboratory inventory, commercial vendors (e.g., chemical compounds, synthesized materials, reagents, assay kits, etc.), and/or datasets.

At the process 140, a validation of the one or more parameters to configure the experimental workflow is performed according to certain embodiments. In some embodiments, performing the validation entails validating the one or more parameters based upon device constraints, experimental constraints, instruction dependencies, and/or experimental design boundaries. In certain embodiments, results from the validation are generated to show detailed steps of the experimental workflow (e.g., cost to execute, estimated time to complete, summary of components, summary of consumables, etc.). In some embodiments, the results may indicate which ones of the one or more parameters were valid and which ones were invalid.

At the process 150, the experimental workflow is configured based upon the validated one or more parameters according to certain embodiments. At the process 160, the configured experimental workflow is transformed into one or more machine executable codes for execution by one or more devices at one or more remote laboratories according to certain embodiments. In various embodiments, the experimental workflow is executed by the one or more devices in accordance with the one or more machine executable codes. For example, the one or more machine executable codes are standardized and reproducible machine executable codes.

In some embodiments, data (e.g., raw data, labeled data, analyzed data, etc.) generated in or near real-time from the execution of the experimental workflow are collected and stored. The data can be accessed via the user interface and/or through any suitable format (e.g., CSV, JavaScript object notation (JSON), etc.).

In certain embodiments, the user interface enables the user to submit the configured experimental workflow to a queue for execution. In some embodiments, the user interface enables the user to request dates for executing the configured experimental workflow. In certain embodiments, the user interface enables the user to assign a funding source for the configured experimental workflow.

In certain embodiments, the user interface enables the user to manage the experimental workflow by allowing access to experimental intent packages. For example, the user interface publishes the experimental intent packages to user groups. As an example, the user interface allows experimental intent scripts available to specified users to be collected. For example, the user interface displays user groups and defined roles for the users.

In some embodiments, the user interface enables the user to manage the experimental workflow by allowing access to modify user roles, add users, and/or delete users associated with the experimental workflow. In certain embodiments, the user interface enables the user to manage the experimental workflow by allowing the selection or addition of a remote laboratory for executing the experimental workflow. In some embodiments, the user interface enables the user to manage the experimental workflow by allowing access to internal/external users, and/or other cloud-based laboratories.

In certain embodiments, the user interface updates the status of the experimental workflow in or near real-time. In some embodiments, the user interface allows the user to view all information associated with the experimental workflows (e.g., status, entered parameters, generated data, data provenance, etc.).

In some embodiments, user inputs received at the user interface and any underlying scripts are used to output human and machine-readable instructions that specify the execution of the experimental workflow.

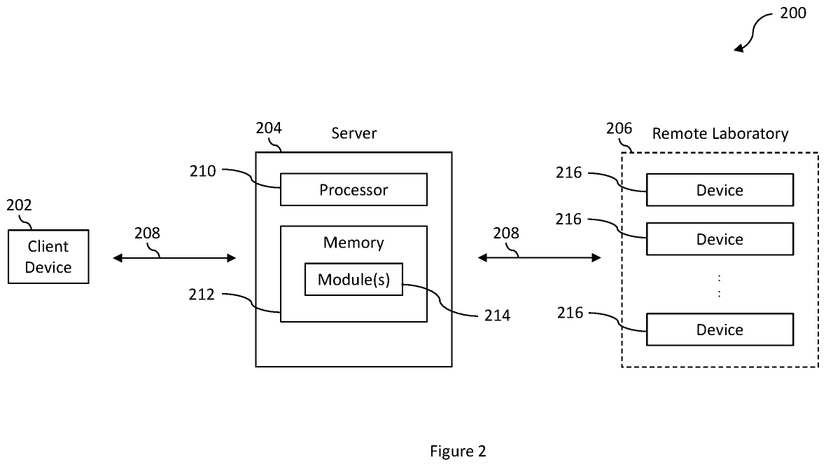

FIG. 2 shows a simplified system for processing experimental workflows according to certain embodiments of the present disclosure. This figure is merely an example, which should not unduly limit the scope of the claims. One of ordinary skill in the art would recognize many variations, alternatives, and modifications. The system 200 includes a client device 202, a server 204 and a remote laboratory 206. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the client device 202, the server 204, and the remote laboratory 206 are communicatively coupled to one another via a suitable network 208 (e.g., Internet, mobile communication network, virtual private network, local area network, etc.). In some embodiments, the server 204 is part of or located at the remote laboratory 206. In certain embodiments, multiple remote laboratories 206 exist in the system 200.

In certain embodiments, a user (e.g., a scientist, a researcher, etc.) may use the client device 202 to communicate with the server 204 for processing experimental workflows executed at the remote laboratory 206. For example, the server 204 executes one or more operations to implement the method 100. In some embodiments, the server 204 includes a processor 210 and a memory 212. For example, the processor 210 is configured to execute instructions and/or one or more modules 214 to perform the various operations associated with the method 100. As an example, the instructions and the one or more modules 214 are stored in the memory 212.

In some embodiments, the remote laboratory 206 employs one or more devices 216 to execute the experimental workflow. For example, the one or more devices 216 may include acoustic liquid handlers (e.g., Beckman Echo 650/525, EDC Biosystems ATS), polymerase chain reaction (PCR) machines (e.g., Bio-Rad CFX96, Bio-Rad CFX384, Thermo Fisher 7500 RT), centrifuges (e.g., Bionex HiG 4), reagent dispensers (e.g., Thermo Scientific Multidrop, Formulatrix Tempest), magnetic purification processors (e.g., Thermo Scientific KingFisher Flex Magnetic Particle Processor Magnetic Plate Separation), liquid handling devices (e.g., Agilent Bravo 96w/384w, Tecan ADP, Hamilton Star), flow cytometers (e.g., Attune NxT Acoustic Focusing Cytometer), live cell formats (e.g., cell imaging), Next-generation sequencing (NGS) sequencers (e.g., Pacific Biosciences RS II sequencer, Illumina HiSeq 4000 sequencer), analytical chemistry devices (e.g., Agilent LC/MS Infinity II), and/or synthetic chemistry robotics. In various embodiments, the one or more devices 216 can be combined in any number of ways. In some embodiments, a mix of human and/or robotic laboratory services are provided to manage and process experimental workflows at the remote laboratory 206.

In certain embodiments, the system 200 is employed for various scientific applications and/or research areas (e.g., drug discovery, cancer research, protein engineering, synthetic biology, high throughput screening, bio-chemical assays, medicinal chemistry, personalized medicine, and/or closed-loop machine learning applications).

In various embodiments, any variety of machine learning approaches may be performed on data generated in the system 200 to further inform and guide next steps in experimentation, improve performance, create new experiments, and/or analyze data across previously disparate scientific applications.

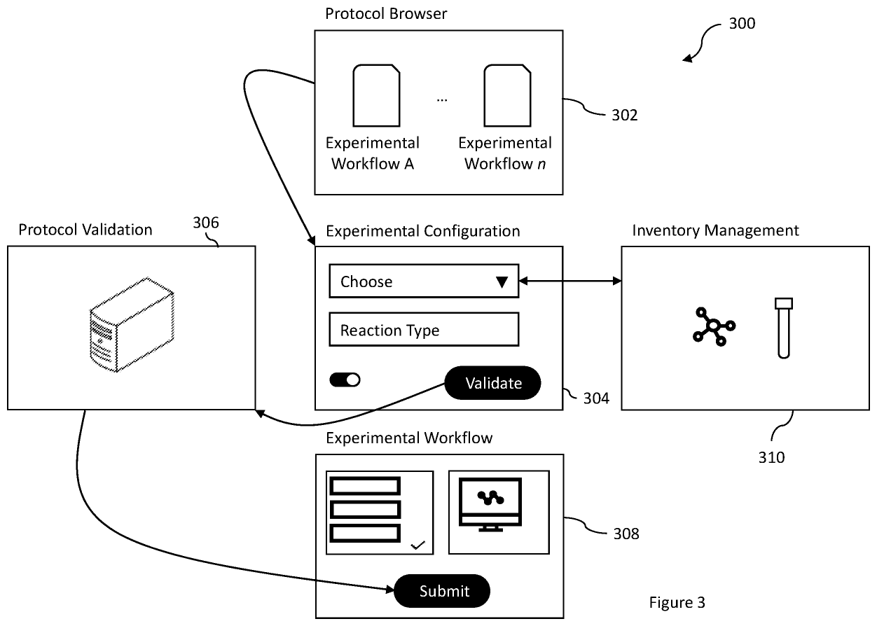

FIG. 3 shows a simplified diagram of various modules for processing experimental workflows according to certain embodiments of the present disclosure. This figure is merely an example, which should not unduly limit the scope of the claims. One of ordinary skill in the art would recognize many variations, alternatives, and modifications. The system 300 includes a protocol browser module 302, an experimental configuration module 304, a protocol validation module 306, an experimental workflow module 308, and an inventory management module 310. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, one or more processes are executed by the modules 302-310 for selecting, configuring, submitting, and/or tracking experimental workflows at one or more remote laboratories.

In certain embodiments, the protocol browser module 302, the experimental configuration module 304, the protocol validation module 306, the experimental workflow module 308, and/or the inventory management module 310 are web-based modules. For example, the modules 302-310 are accessible via the Internet. In some embodiments, the modules 302-310 are part of the one or more modules 214 of FIG. 2.

In some embodiments, the protocol browser module 302 includes functionalities that enable a user to view information regarding experimental workflows. For example, the user can view available experimental workflows, version controlled experimental workflows, and/or linked execution history of experimental workflows. In various embodiments, the protocol browser module 302 includes functionalities that allow the user to customize inputs, parameters, and/or validations.

In certain embodiments, the experimental configuration module 304 includes functionalities that enable the user to manage experimental workflows. For example, the user can view and manage existing experimental workflows as well as request run submissions for new experimental workflows. In some embodiments, the experimental configuration module 304 includes functionalities that allow the user to define protocol design parameters. As an example, the user can configure parameters in an experimental workflow. In certain embodiments, the experimental configuration module 304 includes functionalities that allow the user to access an inventory for sample selection.

In some embodiments, the protocol validation module 306 includes functionalities that enable the user to perform validation of experimental workflows. For example, the user can validate protocol design parameters and/or other parameters used to configure an experimental workflow.

In certain embodiments, the experimental workflow module 308 includes functionalities that allow the user to monitor the execution status of instructions for experimental workflows. In some embodiments, the experimental workflow module 308 includes functionalities that allow the user to view and download data, such as diagnostic data, execution data, and/or other generated data in or near real-time. In various embodiments, the experimental configuration module 304 and/or the experimental workflow module 308 provide application programming interface (API) endpoints.

In some embodiments, the inventory management module 310 includes functionalities that enable the user to perform multi-site management, material management, and/or sample tracking and provenance.

According to certain embodiments, a method for processing one or more experimental workflows includes receiving an indication of an experimental workflow selected by a user. Also, the method includes generating workflow configuration requirements for the experimental workflow. Further, the method includes presenting a user interface to enable input of one or more parameters to configure the experimental workflow in accordance with the workflow configuration requirements. Moreover, the method includes performing a validation of the one or more parameters to configure the experimental workflow and configuring the experimental workflow based at least in part upon the validated one or more parameters. In addition, the method includes transforming the configured experimental workflow into one or more machine executable codes for execution by one or more devices at one or more remote laboratories. For example, the method is implemented according to at least FIG. 1.

According to some embodiments, a system for processing one or more experimental workflows includes one or more processors and a memory storing instructions for execution by the one or more processors. The instructions, when executed by the one or more processors, cause the system to receive an indication of an experimental workflow selected by a user. Also, the instructions, when executed by the one or more processors, cause the system to generate workflow configuration requirements for the experimental workflow. Further, the instructions, when executed by the one or more processors, cause the system to present a user interface to enable input of one or more parameters to configure the experimental workflow in accordance with the workflow configuration requirements. Moreover, the instructions, when executed by the one or more processors, cause the system to perform a validation of the one or more parameters to configure the experimental workflow and configure the experimental workflow based at least in part upon the validated one or more parameters. In addition, the instructions, when executed by the one or more processors, cause the system to transform the configured experimental workflow into one or more machine executable codes for execution by one or more devices at one or more remote laboratories. For example, the system is implemented according to at least FIG. 2.

According to certain embodiments, a non-transitory computer-readable medium stores instructions for processing one or more experimental workflows. The instructions are executed by one or more processors of a computing device. The non-transitory computer-readable medium includes instructions to receive an indication of an experimental workflow selected by a user. Also, the non-transitory computer-readable medium includes instructions to generate workflow configuration requirements for the experimental workflow. Further, the non-transitory computer-readable medium includes instructions to present a user interface to enable input of one or more parameters to configure the experimental workflow in accordance with the workflow configuration requirements. Moreover, the non-transitory computer-readable medium includes instructions to perform a validation of the one or more parameters to configure the experimental workflow and configure the experimental workflow based at least in part upon the validated one or more parameters. In addition, the non-transitory computer-readable medium includes instructions to transform the configured experimental workflow into one or more machine executable codes for execution by one or more devices at one or more remote laboratories. For example, the non-transitory computer-readable medium is implemented according to at least FIG. 1, FIG. 2, and/or FIG. 3.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In still another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Certain implementations may also be used, however, such as firmware or even appropriately designed hardware configured to perform the methods and systems described herein.

The systems' and methods' data (e.g., associations, mappings, data input, data output, intermediate data results, final data results) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A method for processing one or more experimental workflows, the method comprising:
receiving an indication of an experimental workflow selected by a user;
generating workflow configuration requirements for the experimental workflow;
presenting a user interface to enable input of one or more parameters to configure the experimental workflow in accordance with the workflow configuration requirements;
performing a validation of the one or more parameters to configure the experimental workflow;
configuring the experimental workflow based at least in part upon the validated one or more parameters; and
transforming the configured experimental workflow into one or more machine executable codes for execution by one or more devices at one or more remote laboratories.

2. The method of claim 1, further comprising:
executing the experimental workflow by the one or more devices based at least in part upon the one or more machine executable codes at the one or more remote laboratories.

3. The method of claim 1, further comprising:
publishing, based at least in part upon user data and experimental application data, a list of available experimental workflows for the user to select.

4. The method of claim 1, wherein performing the validation of the one or more parameters includes validating the one or more parameters based at least in part upon at least one selected from a group consisting of a device constraint, an experimental constraint, an instruction dependency, and an experimental design boundary.

5. The method of claim 1, wherein the workflow configuration requirements include at least one selected from a group consisting of an input type entity, a generated data, a workflow version, and a published date.

6. The method of claim 1, wherein presenting the user interface to enable input of the one or more parameters further includes:
enabling the user, through the user interface, to submit the configured experimental workflow to a queue for execution.

7. The method of claim 1, wherein presenting the user interface to enable input of the one or more parameters further includes:
enabling the user, through the user interface, to request dates for executing the configured experimental workflow.

8. The method of claim 1, wherein presenting the user interface to enable input of the one or more parameters further includes:
enabling the user, through the user interface, to assign a funding source for the configured experimental workflow.

9. A system for processing one or more experimental workflows, the system comprising:
one or more processors; and
a memory storing instructions that, when executed by the one or more processors, cause the system to:
receive an indication of an experimental workflow selected by a user;
generate workflow configuration requirements for the experimental workflow;
present a user interface to enable input of one or more parameters to configure the experimental workflow in accordance with the workflow configuration requirements;
perform a validation of the one or more parameters to configure the experimental workflow;
configure the experimental workflow based at least in part upon the validated one or more parameters; and
transform the configured experimental workflow into one or more machine executable codes for execution by one or more devices at one or more remote laboratories.

10. The system of claim 9, wherein the instructions, when executed by the one or more processors, further cause the system to:
execute the experimental workflow by the one or more devices based at least in part upon the one or more machine executable codes at the one or more remote laboratories.

11. The system of claim 9, wherein the instructions, when executed by the one or more processors, further cause the system to:
publish, based at least in part upon user data and experimental application data, a list of available experimental workflows for the user to select.

12. The system of claim 9, wherein, the instructions that cause the system to perform the validation of the one or more parameters further comprise instructions that cause the system to validate the one or more parameters based at least in part upon at least one selected from a group consisting of a device constraint, an experimental constraint, an instruction dependency, and an experimental design boundary.

13. The system of claim 9, wherein the workflow configuration requirements include at least one selected from a group consisting of an input type entity, a generated data, a workflow version, and a published date.

14. The system of claim 9, wherein, the instructions that cause the system to present the user interface to enable input of the one or more parameters further comprise instructions that cause the system to enable the user, through the user interface, to submit the configured experimental workflow to a queue for execution.

15. The system of claim 9, wherein, the instructions that cause the system to present the user interface to enable input of the one or more parameters further comprise instructions that cause the system to enable the user, through the user interface, to request dates for executing the configured experimental workflow.

16. The system of claim 9, wherein, the instructions that cause the system to present the user interface to enable input of the one or more parameters further comprise instructions that cause the system to enable the user, through the user interface, to assign a funding source for the configured experimental workflow.

17. A non-transitory computer-readable medium storing instructions for processing one or more experimental workflows, the instructions when executed by one or more processors of a computing device, cause the computing device to:
receive an indication of an experimental workflow selected by a user;
generate workflow configuration requirements for the experimental workflow;
present a user interface to enable input of one or more parameters to configure the experimental workflow in accordance with the workflow configuration requirements;
perform a validation of the one or more parameters to configure the experimental workflow;
configure the experimental workflow based at least in part upon the validated one or more parameters; and
transform the configured experimental workflow into one or more machine executable codes for execution by one or more devices at one or more remote laboratories.

18. The non-transitory computer-readable medium of claim 17, wherein, the instructions when executed by the one or more processors further cause the computing device to:
execute the experimental workflow by the one or more devices based at least in part upon the one or more machine executable codes at the one or more remote laboratories.

19. The non-transitory computer-readable medium of claim 17, wherein, the instructions when executed by the one or more processors further cause the computing device to:
publish, based at least in part upon user data and experimental application data, a list of available experimental workflows for the user to select.

20. The non-transitory computer-readable medium of claim 17, wherein, the instructions when executed by the one or more processors that cause the computing device to present the user interface to enable input of the one or more parameters further cause the computing device to:
enable the user, through the user interface, to submit the configured experimental workflow to a queue for execution;
enable the user, through the user interface, to request dates for executing the configured experimental workflow; and
enable the user, through the user interface, to assign a funding source for the configured experimental workflow.
